(19) United States
(12) Patent Application Publication
(10) Pub. No.: US 2008/0124423 A1
(43) Pub. Date: May 29, 2008

(54) Extrusion die manufacturing method

(76) Inventors: Richard Curwood Peterson, Elmira Heights, NY (US); Alan Thomas Stephens, Beaver Dams, NY (US)

Correspondence Address: CORNING INCORPORATED, SP-TI-3-1, CORNING, NY, 14831, US

(21) Appl. No.: 11/605,755

(22) Filed: Nov. 29, 2006

(51) Int. Cl. B29C 47/30; B29C 35/08; B29C 67/20

(52) U.S. Cl. 425/467; 264/497; 264/219

(57) ABSTRACT

A method of forming an extrusion die comprises depositing at least one layer of a sinterable material, such as binder-free sinterable material, in a plane creating a layer of unsintered material, applying irradiation to the at least one layer of unsintered material along a pattern creating a layer of centered material, and forming the extrusion die as a single, integrally-formed piece by repeating the depositing and irradiating steps in a coordinate direction that is substantially orthogonal to the plane, wherein a new layer is superposed upon a previously sintered layer. The extrusion die formed via this method includes an inlet section having a die inlet face and a plurality of feed channels extending from the inlet face toward a honeycomb-forming section that is spaced from the inlet face and terminates in a die outlet face that includes an array of discharge channels formed from pins. Dies having at least two of the pins coupled to one another by a structural element other than at the pin root may be manufactured by the method.

### FIELD OF THE INVENTION

The present invention relates to extrusion dies and a method for forming an extrusion die that may be utilized for forming honeycomb structures. More particularly, the invention relates to high-strength, single-piece, integrally-formed extrusion dies and methods for forming such extrusion dies.

### DESCRIPTION OF RELATED ART

Honeycomb structures having traverse cross-sectional cellular densities of approximately one tenth to one hundred or more per square centimeter have several uses, including catalysts substrates, solid particulate filter bodies and stationary heat exchangers. The manufacture of these honeycomb structures from plasticized powder batches comprising inorganic powders dispersed in appropriate binders is well known. U.S. Pat. Nos. 3,790,654; 3,885,977; and 3,905,743 describe extrusion dies, processes, and compositions for such manufacture, while U.S. Pat. Nos. 4,992,233 and 5,011,529 describe honeycombs of similar cellular structure extruded from batches incorporating metal powders.

As an example, reference numeral 10 (FIG. 1) generally designates a solid particulate filter body that is generally well known and that may be fabricated utilizing a method as described below. The filter body includes a honeycomb structure 12 formed by a matrix of intersecting, thin, porous walls 14 surrounded by an outer wall 15, which in the illustrated example is provided a circular cross-sectional configuration. The walls 14 extend across and between a first end 13 that includes a first end face 18, and a second end 17 that includes an imposing second end face 20, and form a large number of adjoining hollow passages or cell channels 22 which also extend between and are open at the end faces 18, 20 of the filter body 10. To form the filter 10 (FIGS. 2 and 3), one end of each of the cells 22 may be sealed, a first subset 24 of the cells 22 being sealed at the first end face 18, and a second subset 26 of the cells being sealed at the second end face 20. Either of the end faces 18, 20 may be utilized as the inlet face of the resulting filter 10.

A typical method for manufacturing the honeycomb structure 12 described above includes the steps of mixing various batch constituents with an aqueous vehicle to form a plasticized batch, extruding the plasticized batch through a die to form the walls 14, 15 of the honeycomb structure 12 and the greenware honeycomb structure, and cutting the greenware honeycomb structure to a particular length. The method also includes firing the greenware honeycomb structure to form a hardened honeycomb log structure, cutting the hardened honeycomb log structure to length, masking the end faces 18, 20 of the honeycomb structure 12, plugging certain cell channels 22 of the honeycomb structure 12, and drying the plugged honeycomb structure 12 to form a hardened filter 10.

One of the critical steps in producing these filters is the extrusion formation of the honeycomb structure through an extrusion die. While continually evolving, current commercial honeycomb structure die designs do not depart fundamentally from the die designs shown in the patents as noted herein, being mostly fabricated by the machining of solid metal blocks or billets. To make such a die, multiple apertures (feed holes) are first drilled into one face of the steel billet to form a feed hole array into which a plasticized batch material to be extruded can be supplied at high pressure. A discharge face of the die is thereafter formed by cutting a criss-crossing array of finely machined discharge slots into the billet face opposite the drilled inlet face, the slots being cut to a depth intersecting the ends of the feed holes extending from the inlet face, thereby providing fluid communication therebetween. As a result, plasticized batch material delivered through the feed holes into the intersecting discharge slots is continuously shaped by, and discharged from, the slots to form the intersecting walls and channels of the honeycomb structure.

A number of machining techniques have been adapted for the shaping of metal billets into honeycomb extrusion dies. For softer steels, the feed hole array is typically formed by mechanically drilling, while the discharge slots may be formed by a sawing procedure. If the die is formed of a harder, slower-wearing material such as a stainless steel, electrochemical machining (ECM) and electrical discharge machining (EDM) are more widely used. Generally, inlet face designs continue to feature feed holes in the shape of linear cylinders of a reasonably constant radius and a diameter in spacing dictated by the slot spacing or density of the honeycomb structure of the die.

Heretofore, most machining techniques utilized for forming these extrusion dies are limited to “line-of-sight” elements. Specifically, these techniques cannot be employed to form elements located within an interior of the die that may not be easily accessed or accessed in a straight line from an outer surface of the billet from which the die is machined. These “blind elements” may be extremely useful by allowing adjustment of the flow of the extruded material through the die during the manufacture of the honeycomb structure, such as to reduce back pressure, decrease die wear, improve part fill and proper formation of the honeycomb structure, and the like.

While other techniques have been employed to allow the formation of extrusion dies with blind-elements therein, these techniques do not allow for sufficient flexibility of design and are incapable of forming certain die details. One such method includes forming an extrusion die out of a plurality of die sections or pieces. The die sections are welded or secured to one another via binders thereby forming the entire die. One shortcoming of such dies is added cost and time required in forming such dies, as well as a relative decreased structural integrity as a result of forming the die out of multiple bonded pieces as compared to forming the die from a single-piece billet. Rapid prototyping techniques have employed the process of sintering powdered metals combined with a binding material such as a polymer or wax-based binder. In these processes, the die is constructed from the powdered metal and binder combination and then sintered into a solid die. These methods allow for the formation of die details unavailable via convention methods utilizing machined billets. However, the required use of the binder within these processes necessarily results in limitations for their use. Specifically, certain details formed within the pre-sintered dies do not retain sufficient shape, or in some cases cannot survive, the sintering process. More specifically, a pre-sintered die typically has a strength of within the range of 10 to 20 psi that allows gentle manipulation of the part, with the binder providing the structural integrity. However, as the part is sintered, a significant portion of the binder material is burned off and the strength of part approaches 3000 psi to 5000 psi prior just to sintering of the metal powder. As a result, distortion of fragile details may occur within the die. Further, certain details, such as those that would be suspended from a portion of the pre-sintered die, do not survive the sintering process.

Any one of the methods described above may also be relatively time consuming and expensive, with the average time to building ranging from days to weeks, at significant cost.

A method for manufacturing an extrusion die that provides the die with a relatively high structural integrity, while allowing blind-elements to be formed on the interior thereof so as to improve the flow characteristics of the extrusion die is desired. Further, the desired method should reduce the time and cost typically associated with the formation of extrusion dies.

### SUMMARY OF THE INVENTION

According to a first aspect, the present invention is a method of forming an extrusion die, comprising the steps of depositing at least one layer of a binder-free sinterable material in an x-y plane creating a layer of unsintered material; applying irradiation to the at least one layer of unsintered material along a pattern creating a layer of sintered material; and forming the extrusion die as a single, integrally formed piece by repeating the steps of depositing and applying in a z coordinate direction that is substantially orthogonal to the x-y plane, wherein a new layer is superposed on a previously-formed layer of sintered material wherein the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots, and wherein the feed channels are in fluid communication with the discharge slots.

According to further embodiments of the invention, a method for forming an extrusion die is provided comprising the steps of depositing at least one layer of a sinterable material creating a layer of unsintered material; irradiating the at least one layer of unsintered material along a pattern creating a layer of sintered material; and forming the extrusion die as a single, integrally formed piece by repeating the depositing and irradiating steps, wherein a new layer is superposed on a previously-formed layer of sintered material, the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots interconnected with the discharge slots, the forming step includes forming the extrusion die such that the criss-crossing array of open discharge slots are formed by a plurality of pins, and wherein at least two of the pins are coupled to one another by a structural element extending between the pins and spaced along a length of the pins.

In yet another embodiment, a method of forming an extrusion die is provided, comprising the steps of depositing at least one layer of a sinterable material in an x-y plane creating a layer of unsintered material; applying a laser to the at least one layer of unsintered material along a pattern creating a layer of sintered material; and forming the extrusion die as a single, integrally formed piece by repeating steps (a) and (b) in a z coordinate direction that is substantially orthogonal to the x-y plane, wherein a new layer is superposed on a previously-formed layer of sintered material, the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots, the feed channels are in fluid communication with the discharge slots, and wherein the forming step includes forming the honeycomb forming section prior to forming the inlet section.

In another aspect, the invention is a method of forming an extrusion die, comprising the steps of creating a layer of unsintered material; sintering the layer of unsintered material to creating a layer of sintered material; and forming the extrusion die by repeating steps of creating and sintering wherein new layers are superposed on a previously-formed layers of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the step of forming includes forming the honeycomb forming section prior to forming the inlet section.

According to yet another aspect of the invention, a method of forming an extrusion die is provided, comprising the steps of applying a first layer of sintered material; and thereafter forming new layers superposed on the first layer of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the step of forming includes forming the honeycomb forming section prior to forming the inlet section.

According to further embodiments, a method of forming an extrusion die is provided, comprising the steps of applying a first layer of sintered material; and thereafter forming new layers superposed on the first layer of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the sintered material is binder-free in a pre-sintered state.

According to further embodiment, the invention is an extrusion die, comprising an inlet section having a die inlet face and a plurality of feed channels extending from the inlet face toward a honeycomb forming section that is spaced from the inlet face and terminates in a die outlet face that includes an array of discharge slots interconnected with the discharge slots wherein the discharge slots are formed by an arrangement of pins, said pins having a pin root and an end at the outlet face and at least two of the pins are coupled to one another by a structural element other than at the pin root.

The present inventive method for manufacturing an extrusion die produces a single-piece, integrally-formed die with a relatively high structural integrity, while allowing blind-elements to be formed on the interior thereof so as to improve the flow characteristics of the extrusion die as desired. Further, the desired method reduces the time and cost typically associated with the formation of extrusion dies, and is particularly well suited for the required purpose.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of extruded filter body including a first end having a plurality of open-ended cell channels.

FIG. 2 is a perspective view of the extruded filter body wherein a first subset of cell channels are plugged on a first end, and a second subset of channels are open-ended on the first end.

FIG. 3 is an end view of a filter body including a second end, wherein the first subset of the cell channels are open-ended at the second end and a second subset of the cell channels are plugged at the second end.

FIG. 4 is a perspective end view of the extrusion die formed via the present inventive process.

FIG. 5 is a partial perspective view of an extrusion die formed via the present invention process, wherein the extrusion die includes a plenum formed by cooperating recesses formed at roots of multiple die pins;

FIG. 6 is a partial side view of the extrusion die of FIG. 5;

FIG. 7 is an alternative embodiment of the extrusion die including a plurality of divots located along a length of a plurality of pins of the extrusion die, wherein the divots are spaced from a honeycomb forming section and a distal end of the pins;

FIG. 8 is a side perspective view of the alternative embodiment extrusion die of FIG. 7;

FIG. 9 is a perspective end view of a cutaway portion of another embodiment of the extrusion die, wherein the extrusion die includes a plurality of feed holes having recesses and shoulders spaced along a length thereof;

FIG. 10 is a partial perspective view of a square-type extrusion die;

FIG. 11 is a cutaway perspective view of the square-type extrusion die that includes a plurality of cross-flow channels of the extrusion die of FIG. 10;

FIGS. 12A-12C are schematic side views of a pin-down manufacturing process utilized within the present inventive forming method; and

FIGS. 13A-13C are partial end perspective views of another embodiment of the extrusion die that may be formed with the pins-down manufacturing process of FIGS. 12A-12C, and that include a plurality of structural reinforcement members extending between pins of the extrusion die.

### DETAILED DESCRIPTION OF THE PREFERRED EMBODIMENTS

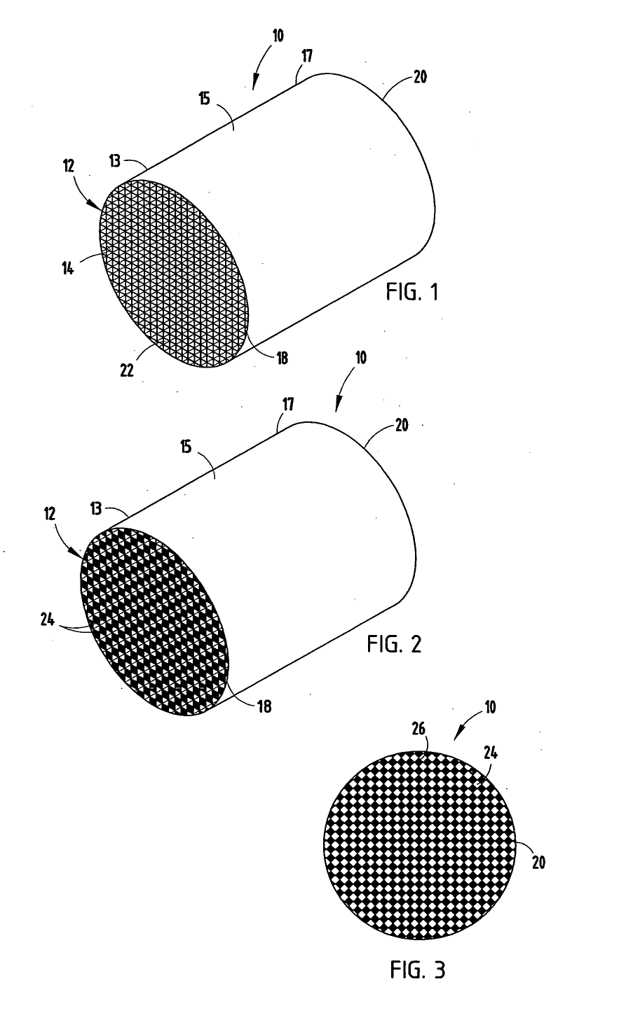

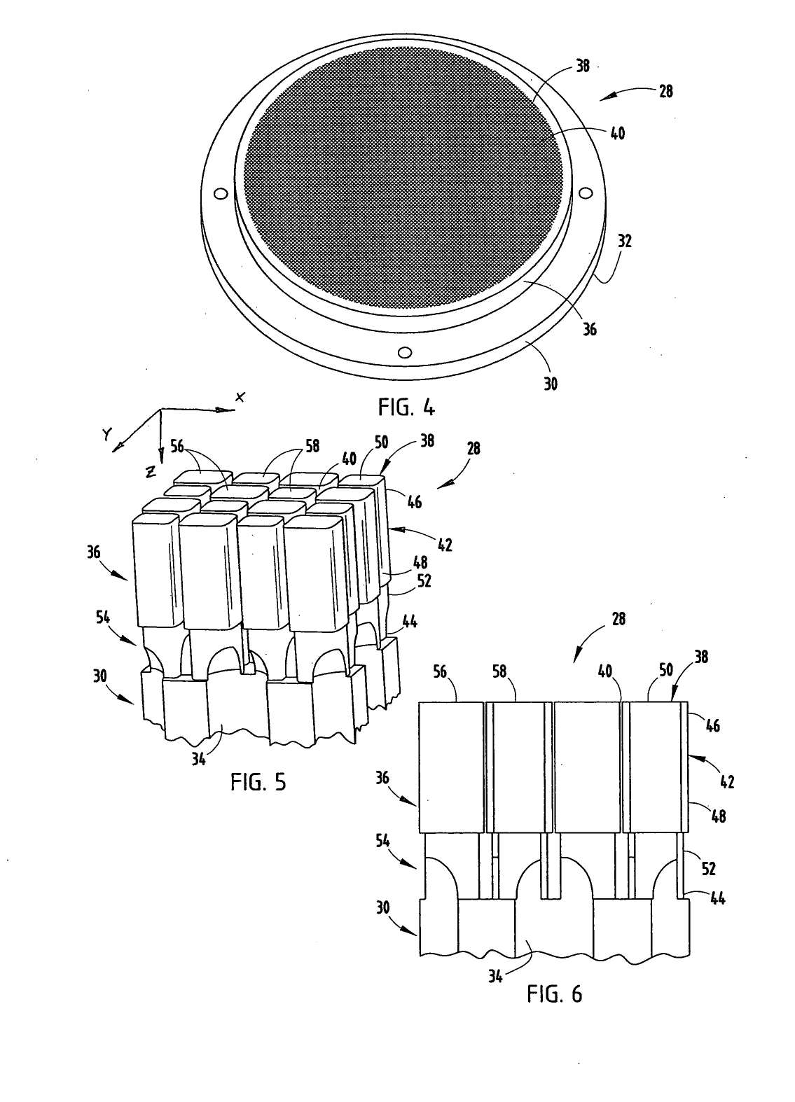

For purposes of description herein, the terms “upper,” “lower,” “right,” “left,” “rear,” “front,” “vertical,” “horizontal,” and derivatives thereof shall relate to the invention as oriented in FIGS. 1 and 5. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The present inventive method includes the solidifying of superposed layers of powdered materials, such as metals and ceramics, to form an extrusion die 28 (FIG. 4-6). Specifically, the method includes sintering the layers of powdered material by irradiation corresponding to the shape of the extrusion die. More specifically, the method includes depositing a layer of a binder-free, sinterable material in an X-Y plane creating a layer of unsintered material, and applying irradiation to the layer of unsintered material along a pattern creating a layer of sintered material. The method further includes forming the extrusion die as a single, integrally formed piece by repeating the depositing and irradiation steps in a Z coordinate direction that is substantially orthogonal to the X-Y plane such that subsequently-formed layers are superposed over previously formed layers. The extrusion die formed via this method includes an inlet section 30 having a die inlet face 32 and a plurality of open-ended feed channels 34 (FIG. 5) extending from the inlet face 32 toward a honeycomb forming section 36 that is spaced from the inlet face 32 and terminates in a die outlet face 38 that includes a criss-crossing array of open discharge slots 40, wherein in operation (during plasticized batch feed) the feed channels 34 are in fluid communication with the discharge slots 40.

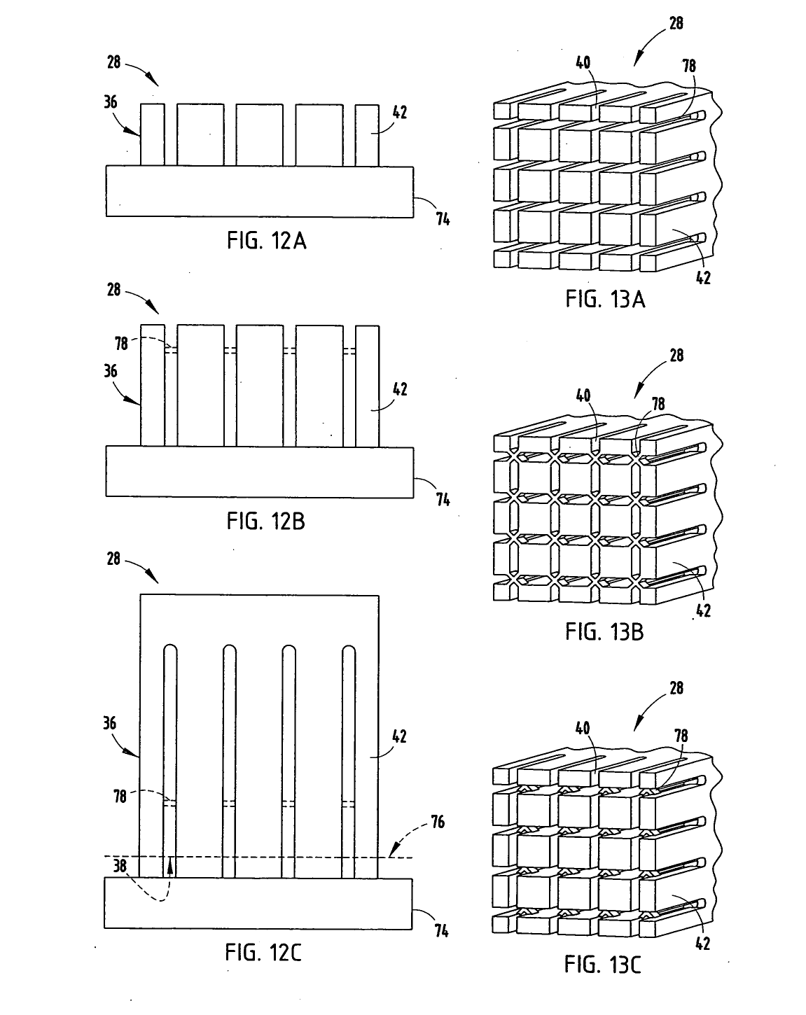

The depositing step includes depositing a layer of an unsintered, powdered material such as a metal, ceramic, or metal and ceramic combination. These powdered materials preferably comprise tool steels and more preferably comprise corrosive resistant super alloys such as high-strength stainless steels, however, other materials suitable for the formation of the extrusion die 28 may be utilized. It is noted that the powdered material does not include any binder materials therein, such as polymers or wax-based binders. Preferably, a layer of the powdered material at a depth of between 0.0001 inches and 0.01 inches, or even 0.0002 inches and 0.002 inches is deposited on a substrate (FIG. 12A-C) and may or may not be ultimately adhered thereto. The powdered material may have a median particle size of less than 200 microns, or even less than 100 microns, or even less than 50 microns. Median particle extrusion dies for manufacturing high cell density (e.g., >200 cells/inch) dies. The unsintered layer of powdered material is then irradiated via, for example, a laser, thereby sintering the material into a solid layer. The laser traces a pattern corresponding to the desired layout of the extrusion die 28 at a given layer. The irradiation step is described in detail in U.S. Pat. No. 5,753,717, issued May 19, 1998, entitled Method and Apparatus For Producing a Three-Dimensional Object, and U.S. Pat. No. 6,042,774, issued Mar. 28, 2000, entitled Method For Producing a Three-Dimensional Object, which are incorporated herein by reference in their entirety. For the purposes of the present inventive method, the irradiation step as applied allows the formation of the extrusion die 28 directly from the powdered material without requiring the use of binder materials therein, thereby allow the manufacture of die details previous unattainable, as described below. The depositing and irradiation steps are repeated by depositing a new layer of the powdered material onto the already formed portion of the extrusion die 28 until the entire extrusion die 28 has been constructed. This process allows the formation of “blind-elements” within a relative interior of the extrusion die 28 not available via line-of-sight machining techniques, such as bridging elements, detailed contours, and smooth transition sections.

As an example of the extrusion die configurations available when employing the inventive method disclosed herein, FIGS. 5 and 6 illustrate a portion of the extrusion die 28 that includes the inlet section 30 and the honeycomb forming section 36. The slots 40 are formed by a plurality of pins 42, wherein each pin includes a root portion 44, a distal end 46 extending away from the inlet section 30, an outer surface 48 extending between the root portion 44 and the distal end 46, and an end surface 50, wherein the end surfaces 50 of each of the pins 42 cooperate with one another to form the die outlet face 38. In the illustrated example, each of the pins 42 is formed to include a recess (area of smaller dimension) surrounding and located near the root portion 44 of each of the pins 42, and extending into the outer surface 48 thereof. Recesses 52 of the pins 42 cooperate with one another to form a plenum 54 that allows an equalization of pressure of the extruded material between the pins 42 and thus the slots 40. The present inventive method allows construction of the plenum 54 at the intersection of the feedholes and the slots within a honeycomb-forming section 36 having pins of equal size, or as in the illustrated example, pins having varying cross-sectional configurations. Additionally, the surface areas on the end surface 50 thereof may be formed of larger pins 56 interspaced with smaller pins 58. Specifically, the present inventive process allows an equal distribution of the plenum 54 to be formed regardless of the size of the pins 42, and eliminates the difficulties associated with conventional machining, such as EDM machining, wherein the recesses 52 would be disproportionately deeper within the larger pins 56.

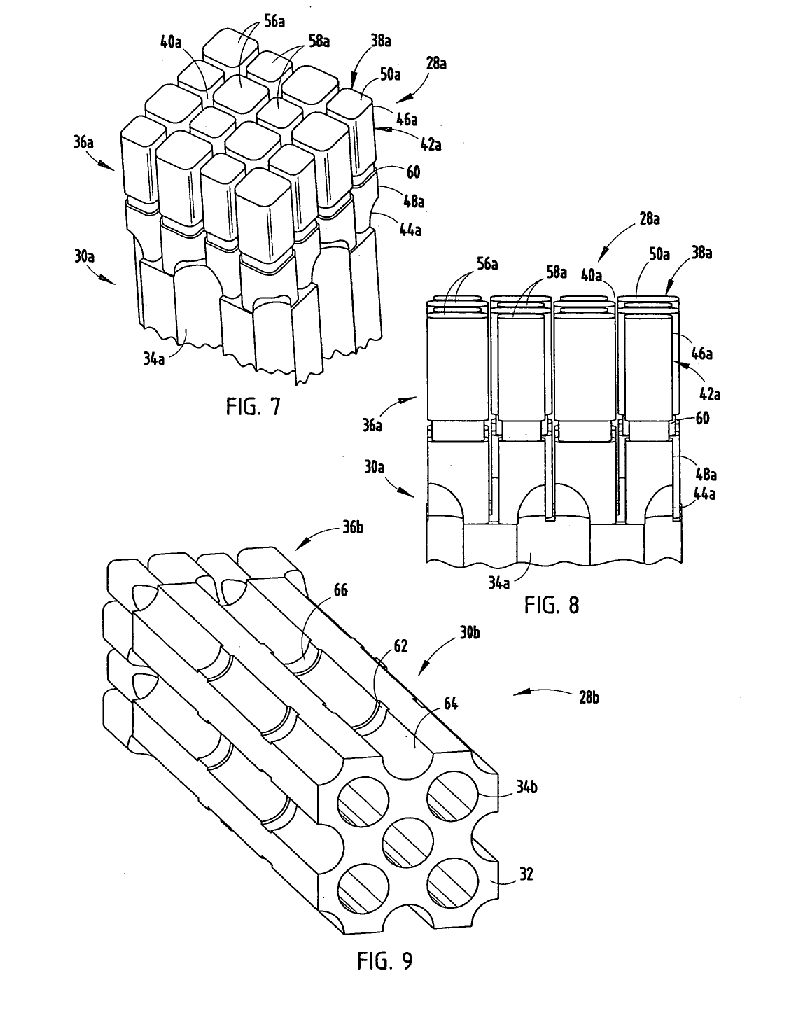

Another embodiment of the extrusion die 28a formed via the present inventive process is illustrated in FIGS. 7 and 8 and includes the formation of a recessed divot 60 extending into the outer surface 48a of each of the pins 42a, preferably extending into the pins to a common depth. The reference numeral 28a generally refers to another embodiment of the present invention. Since extrusion die 28a is similar to the previously described extrusion die 28, similar parts appearing in FIGS. 5 and 6 and FIGS. 7 and 8, respectively, are represented by the same, corresponding numerals except for the suffix “a” in the numerals of the latter. The divots 60 function so as to increase the impedance during the extrusion process along the length of the pins 42a so as to provide a relatively equal extrusion pressure between neighboring pins and prevent deformations to the extruded honeycomb structure 12, such as web tears, cracking and the like. It is noted that the illustrated extrusion die 28a includes larger pins 56a and smaller pins 58a, thereby necessitating the use of the present inventive method in order to properly form the divots 60 therein. For example, radii may be formed on the pins and also on the corners within the divots.

In another embodiment, the inlet section 30b (FIG. 9) of the extrusion die 28b includes a recess 62, such as a groove, spaced along the length of and extending inwardly into the wall 64 that defines each of the feed channels 34, or alternatively, an inwardly-extending shoulder 66. The reference numeral 28b generally refers to another embodiment of the present invention. Since extrusion die 28b is similar to the previously described extrusion die 28, similar parts appearing in FIGS. 5 and 6 and FIG. 9, respectively, are represented by the same, corresponding numerals except for the suffix “b” in the numerals of the latter. The recess 62 and/or the shoulder 66 are useful for ensuring complete mixing of the batch of materials as the batch materials are extruded through the body of the extrusion die 28b.

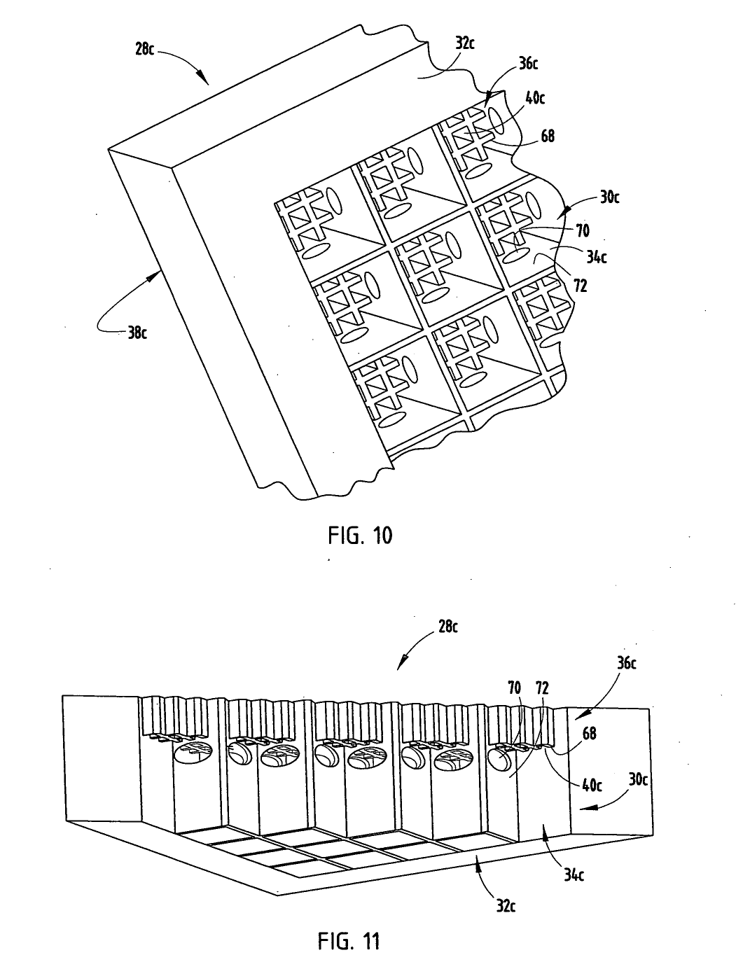

A square-type extrusion die is illustrated in FIGS. 10 and 11 and includes an inlet section 30c having a die inlet face 32c and a plurality of feed channels 34c, and a honeycomb forming section 36c having a die outlet face 38c and a plurality of slots 40c. The reference numeral 28c generally refers to another embodiment of the present invention. Since extrusion die 28c is similar to the previously described extrusion die 28, similar parts appearing in FIGS. 5 and 6 and FIGS. 10 and 11, respectively, are represented by the same, corresponding numerals except for the suffix “c” in the numerals of the latter. The feed slots 40c are formed by a grid work 68. The extrusion die 28c includes a plurality of cross-flow channels extending through the sidewalls 72 of the feed channels 34c and are located proximate the honeycomb-forming section 36c. The cross load channels 70 allow the extrudate to cross-flow between feed channels 34c thereby balancing the pressure within the body of the extrusion die 28c during the extrusion process. In addition, the present invention method allow a progressively finer array of feed holes providing batch materials to the slots (not shown).

The present inventive process further allows construction of the extrusion die 28 in a pin-down orientation. Specifically, the pins 42 are constructed first so as to minimize the movement thereof as the die is constructed. Specifically, a building platform 74 (FIG. 12A) is used as a substrate for the pins 42 as they are constructed. Additional layers of the powdered material build the extrusion die 28 (FIG. 12B) in a pins-down orientation until the die is complete or until such structure is available that holds the pins 42 in their proper orientation and position (FIG. 12C). Subsequently, the pins 42, and as a result the extrusion die 28, are cut along a line 76, thus freeing them from the building platform 74. It should be noted that previous construction methods have required a “pins-up” orientation during the construction of the associated extruded die, and that such manufacturing methods allow the pins to move during the depositing and sintering processes resulting in an out of tolerance die, or a die that must be machined via conventional means subsequent to the formation thereof. Referring to the die details earlier described, such subsequent machining may not allow for the proper formation and tolerancing thereof. Moreover, manufacturing the pins 42 first by placing the same on the build platform 74 allows accurate pin placement and control, a critical factor during the eventual extrusion process.

In certain situations, the length and/or configuration of the pins 42 may require structural reinforcement or bracing of the same during construction of the extrusion die 28. FIG. 13A illustrates a standard pin that may be machined using any number of traditional machining techniques. However, as the length of the pins 42 within the extrusion die 28 are increased, structural instability ensues. As a result, a plurality of structural members 78 are formed between adjacent pins 42. In the illustrated example, the structural support members are provided in the form of an X-shaped lattice work extending between adjacent pins 42, thus strengthening the pins as they are being constructed. As best illustrated in FIG. 13C, these structural elements 78 may be offset from the distal end of the pins 42. Subsequent to formation of the extrusion die 28, conventional machining techniques may be utilized to remove the structural elements 78 from within the slots 40.

The present inventive method for manufacturing an extrusion die produces a single-piece, integrally-formed die with a relatively high structural integrity, while allowing blind-elements to be formed on the interior thereof so as to improve the flow characteristics of the extrusion die as desired. Further, the desired method reduces the time and cost typically associated with the formation of extrusion dies, and is particularly well suited for the required purpose.

What is claimed is:

1. A method of forming an extrusion die, comprising the steps of:
(a) depositing at least one layer of a binder-free sinterable material in an x-y plane creating a layer of unsintered material;
(b) applying irradiation to the at least one layer of unsintered material along a pattern creating a layer of sintered material; and
(c) forming the extrusion die as a single, integrally formed piece by repeating steps (a) and (b) in a z coordinate direction that is substantially orthogonal to the x-y plane, wherein a new layer is superposed on a previously-formed layer of sintered material wherein the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots, and wherein the feed channels are in fluid communication with the discharge slots.

2. The method of claim 1, wherein the forming step includes forming the extrusion die such that the criss-crossing array of open discharge slots are formed by a plurality of pins, and wherein the cross-sectional area of at least one of the pins differs along a length of the at least one pin.

3. The method of claim 2, wherein the forming step further includes forming the extrusion die such that each pin includes a root coupled to the inlet section and an outer surface cooperating to form the outlet face of the extrusion die, and wherein the cross-sectional area of the at least one pin is less at the root of the at least one pin than at a given point along the length of the pin spaced from the root of the at least one pin.

4. The method of claim 2, wherein the forming step further includes forming the extrusion die such that the cross-sectional area of a majority of each of the pins is less at the root of the pins than at the given point along the length of the pin, thereby forming a plenum.

5. The method of claim 1, wherein the forming step further includes forming the extrusion die such that each pin includes a root coupled to the inlet section and an outer surface cooperating to form the outlet face of the extrusion die, and wherein the cross-sectional area of the at least one pin is less at a point spaced from the root and the outer surface of the at least one pin.

6. The method of claim 1, wherein the forming step further includes forming the extrusion die such that the cross-sectional area of at least one of the feed holes differs along a length thereof.

7. The method of claim 6, wherein the forming step further includes forming the extrusion die such that at least one of the feed holes includes an outwardly extending recess spaced from the inlet face and the honeycomb forming section.

8. The method of claim 6, wherein the forming step further includes forming the extrusion die such that at least one of the feed holes includes an inwardly extending shoulder spaced from the inlet face and the honeycomb forming section.

9. The method of claim 1, wherein the forming step further includes forming the extrusion die such that at least two of the feed holes are coupled to one another by a channel extending therebetween and spaced from the inlet face and the honeycomb forming section.

10. The method of claim 1, wherein the depositing step includes providing the sinterable material as comprising a powdered metal.

11. The method of claim 1, wherein the depositing step includes providing the sinterable material as comprising a powdered ceramic.

12. The method of claim 1, wherein the step of applying irradiation comprises applying a laser.

13. The method of claim 1, wherein the depositing step includes depositing a powdered material at a thickness within a range of from about 0.0001 inches to about 0.01 inches.

14. The method of claim 1, further including a step of machining the extrusion die subsequent to the forming step.

15. The method of claim 14, wherein the step of machining includes at least one of a group including bit drilling, gun drilling, ECM drilling, wire EDM slitting, gang saw slitting, abrasive wheel grinding, and EDM plunge processing.

16. The method of claim 1, further including a step of coating the extrusion die subsequent to the step of forming with at least one of a group including nickel, tungsten carbide, and titanium carbo-nitride.

17. A method of forming an extrusion die, comprising the steps of:
(a) depositing at least one layer of a sinterable material creating a layer of unsintered material;
(b) irradiating the at least one layer of unsintered material along a pattern creating a layer of sintered material; and
(c) forming the extrusion die as a single, integrally formed piece by repeating steps (a) and (b), wherein a new layer is superposed on a previously-formed layer of sintered material, the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots interconnected with the discharge slots, the forming step includes forming the extrusion die such that the criss-crossing array of open discharge slots are formed by a plurality of pins, and wherein at least two of the pins are coupled to one another by a structural element extending between the pins and spaced along a length of the pins.

18. The method of claim 17, wherein the step of forming includes forming the extrusion die such that the structural element is spaced from the inlet face and the honeycomb forming section.

19. The method of claim 18, wherein the forming step includes forming the extrusion die such that the structural element comprises an X-shaped cross-sectional configuration.

20. The method of claim 17, further including a step of:
removing the structural element from the extrusion die subsequent to the forming extrusion die.

21. A method of forming an extrusion die, comprising the steps of:
(a) depositing at least one layer of a sinterable material in an x-y plane creating a layer of unsintered material;
(b) applying a laser to the at least one layer of unsintered material along a pattern creating a layer of sintered material; and
(c) forming the extrusion die as a single, integrally formed piece by repeating steps (a) and (b) in a z coordinate direction that is substantially orthogonal to the x-y plane, wherein a new layer is superposed on a previously-formed layer of sintered material, the extrusion die includes an inlet section having a die inlet face and a plurality of open-ended feed channels extending from the inlet face toward a honeycomb forming section that is spaced from the inlet face and terminates in a die outlet face that includes a criss-crossing array of open discharge slots, the feed channels are in fluid communication with the discharge slots, and wherein the forming step includes forming the honeycomb forming section prior to forming the inlet section.

22. The method of claim 21, wherein the forming step includes forming the extrusion dies such that the criss-crossing array of open discharges slots are formed by a plurality of pins each having a root coupled to the inlet section and a distal end extending away from the root, and wherein the forming step further includes forming the distal end of at least one of the pins prior to forming the root of the at least one pin.

23. A method of forming an extrusion die, comprising the steps of:
creating a layer of unsintered material;
sintering the layer of unsintered material to creating a layer of sintered material; and
forming the extrusion die by repeating steps of creating and sintering wherein new layers are superposed on a previously-formed layers of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the step of forming includes forming the honeycomb forming section prior to forming the inlet section.

24. A method of forming an extrusion die, comprising the steps of:
applying a first layer of sintered material; and thereafter
forming new layers superposed on the first layer of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the step of forming includes forming the honeycomb forming section prior to forming the inlet section.

25. A method of forming an extrusion die, comprising the steps of:
applying a first layer of sintered material; and thereafter
forming new layers superposed on the first layer of sintered material, the extrusion die including an inlet section having a die inlet face and a plurality of feed channels extending from the inlet face toward a honeycomb forming section that is spaced from the inlet face and terminates in a die outlet face that includes discharge slots, the feed channels are interconnected with the discharge slots, and wherein the sintered material is binder-free in a pre-sintered state.

26. An extrusion die, comprising:
an inlet section having a die inlet face and a plurality of feed channels extending from the inlet face toward a honeycomb forming section that is spaced from the inlet face and terminates in a die outlet face that includes an array of discharge slots interconnected with the discharge slots wherein the discharge slots are formed by an arrangement of pins, said pins having a pin root and an end at the outlet face and at least two of the pins are coupled to one another by a structural element other than at the pin root.
